(19) United States
(12) Patent Application Publication
(10) Pub. No.: US 2020/0201122 A1
(43) Pub. Date: Jun. 25, 2020

(54) QUANTUM DOT LIQUID CRYSTAL PANEL, AND METHOD MANUFACTURING SAME

(71) Applicant: WUHAN CHINA STAR OPTOELECTRONICS TECHNOLOGY CO., LTD., Wuhan, Hubei (CN)

(72) Inventors: Chaoqun YANG, Wuhan, Hubei (CN); Changohih HUANG, Wuhan, Hubei (CN)

(21) Appl. No.: 16/347,836

(22) PCT Filed: Dec. 14, 2018
(86) PCT No.: PCT/CN2018/121042

§ 371 Date: May 7, 2019

(30) Foreign Application Priority Data
Nov. 21, 2018 (CN) 201811388350.4

(51) Int. Cl. G02F 1/13357; G02F 1/1335; G02F 1/1339

(52) U.S. Cl. CPC G02F 1/133617; G02F 1/13394; G02F 1/133512

(57) ABSTRACT

A quantum dot liquid crystal panel and a method manufacturing the same are provided. The method includes providing an array substrate and a color film substrate including an array of quantum dot color resistances, injecting a self-aligning liquid crystal material between the array substrate and the color film substrate, wherein the self-aligning liquid crystal material includes liquid crystal molecules and a self-aligning material, heating to a temperature between a first threshold and a second threshold to let the self-aligning material move to a surface of the array substrate and the color film substrate to form a first self-aligning film and a second self-aligning film respectively.

### FIELD OF INVENTION

The present disclosure relates to liquid crystal panel technologies, and more particularly to a quantum dot liquid crystal panel and a method manufacturing the same.

### BACKGROUND OF INVENTION

Quantum dots (QDs) materials have a wide absorption peak and a narrow emission peak, which allows them to exhibit higher purity in color display, thereby increasing the liquid crystal displays (LCDs) color gamut and increasing the competitiveness of LCD panels. The existing quantum dot liquid crystal displays (QD-LCDs) follow the manufacturing process of LCDs, and liquid crystal alignment is one of the key steps. The traditional LCDs alignment liquid (polyimides, PIs) needs to be cured at 220-240° C. However, due to the high heat sensitivity of QDs, high temperature damages stability of the QDs material and reduces its luminescence performance. At the same time, due to the usage of PIs, the PI liquid needs to be coated on the in-cell polarizers (wire-grid polarizing parts, WGPs), and there is a risk that the WGPs are destroyed and the PI liquid cannot be adsorbed on the WGPs.

Therefore, the prior art has drawbacks and is in urgent need of improvement.

### SUMMARY OF INVENTION

In view of the above, the present disclosure provides a quantum dot liquid crystal panel, and a method manufacturing the same to solve the current situation that it cannot realize the low-temperature alignment when the current QD-LCDs adopt PIs for alignment, and solve the issue that PIs cannot be adsorbed on the surface of nanoimprinted polarizer.

In order to achieve above-mentioned object of the present disclosure, one embodiment of the disclosure provides a method of manufacturing a quantum dot liquid crystal panel comprising steps of: at step S10, providing an array substrate and a color film substrate, wherein the color film substrate comprises an array of red quantum dot color resistances, green quantum dot resistances, and blue quantum dot color resistances, at step S20, attaching the array substrate and the color film substrate and injecting a self-aligning liquid crystal material between the array substrate and the color film substrate, wherein the self-aligning liquid crystal material comprises liquid crystal molecules and self-aligning material, and at step S30, heating the self-aligning liquid crystal material, wherein a temperature of the self-aligning liquid crystal material is keeping between a first threshold and a second threshold to let the self-aligning material move to a surface of the array substrate and the color film substrate to form a first self-aligning film and a second self-aligning film.

In one embodiment of the disclosure, the first threshold is a temperature corresponding to liquid crystal molecules reaching its clearing point, and the second threshold is 150° C.

In one embodiment of the disclosure, the method further comprises step of S40: aligning liquid crystal molecules by exposing to ultraviolet light.

Furthermore, another embodiment of the disclosure provides a quantum dot liquid crystal panel comprising a color film substrate, an array substrate, a blue backlight source, a liquid crystal layer, a first self-aligning film, and a second self-aligning film.

The color film substrate comprises a base substrate and a red quantum dot color resistance, a green light quantum dot color resistance and a blue quantum dot color resistance repeatedly disposed on the base substrate in intervals.

The array substrate and the color film substrate are disposed opposite to each other.

The blue backlight source is disposed on one side of the array substrate opposite to another side of the array substrate facing the color film substrate.

The liquid crystal layer is disposed between the color film substrate and the array substrate.

The first self-aligning film is formed on a surface of the array substrate facing the color film substrate.

The second self-aligning film is formed on a surface of the color film substrate facing the array substrate.

The liquid crystal layer, the first self-aligning film and the second self-aligning film are formed by self-aligning liquid crystal material at a temperature between a first threshold and a second threshold.

In one embodiment of the disclosure, the self-aligning liquid crystal material comprises liquid crystal molecules and self-aligning material.

In one embodiment of the disclosure, the first threshold is a temperature corresponding to liquid crystal molecules reaching its clearing point, and the second threshold is 150° C.

In one embodiment of the disclosure, the quantum dot liquid crystal panel further comprises a blue light absorption layer between the red quantum dot color resistance and the base substrate, and between the green light quantum dot color resistance and the base substrate.

In one embodiment of the disclosure, the quantum dot liquid crystal panel further comprises a water oxygen barrier layer disposed on the red quantum dot color resistance, the green light quantum dot color resistance and the blue quantum dot color resistance. The water oxygen barrier layer is a light transmissive material.

In one embodiment of the disclosure, the quantum dot liquid crystal panel further comprises a black shading layer disposed in intervals between the red quantum dot color resistance, the green light quantum dot color resistance and the blue quantum dot color resistance to separate the red quantum dot color resistance, the green light quantum dot color resistance and the blue quantum dot color resistance.

In one embodiment of the disclosure, the quantum dot liquid crystal panel further comprises a plurality of reflecting layers disposed between the red quantum dot color resistance, the green light quantum dot color resistance and the blue quantum dot color resistance to separate the red quantum dot color resistance, the green light quantum dot color resistance and the blue quantum dot color resistance.

In one embodiment of the disclosure, the quantum dot liquid crystal panel further comprises a plurality of pillars disposed between the array substrate and the color film substrate. The plurality of pillars are disposed corresponding to the plurality of reflecting layers.

Furthermore, another embodiment of the disclosure provides a quantum dot liquid crystal panel comprising a color film substrate, an array substrate, a blue backlight source, a liquid crystal layer, a first self-aligning film, and a second self-aligning film.

The color film substrate comprises a base substrate and a red quantum dot color resistance, a green light quantum dot color resistance and a blue quantum dot color resistance repeatedly disposed on the base substrate in intervals.

The array substrate and the color film substrate are disposed opposite to each other.

The blue backlight source is disposed on one side of the array substrate opposite to another side of the array substrate facing the color film substrate.

The liquid crystal layer is disposed between the color film substrate and the array substrate.

The first self-aligning film is formed on a surface of the array substrate facing the color film substrate.

The second self-aligning film is formed on a surface of the color film substrate facing the array substrate. The liquid crystal layer, the first self-aligning film and the second self-aligning film are formed by self-aligning liquid crystal material.

In one embodiment of the disclosure, the self-aligning liquid crystal material comprises liquid crystal molecules and self-aligning material.

In one embodiment of the disclosure, the quantum dot liquid crystal panel further comprises a blue light absorption layer between the red quantum dot color resistance and the base substrate, and between the green light quantum dot color resistance and the base substrate.

In one embodiment of the disclosure, the quantum dot liquid crystal panel further comprises a water oxygen barrier layer disposed on the red quantum dot color resistance, the green light quantum dot color resistance and the blue quantum dot color resistance. The water oxygen barrier layer is a light transmissive material.

In one embodiment of the disclosure, the quantum dot liquid crystal panel further comprises a black shading layer disposed in intervals between the red quantum dot color resistance, the green light quantum dot color resistance and the blue quantum dot color resistance to separate the red quantum dot color resistance, the green light quantum dot color resistance and the blue quantum dot color resistance.

In one embodiment of the disclosure, the quantum dot liquid crystal panel further comprises a plurality of reflecting layers disposed between the red quantum dot color resistance, the green light quantum dot color resistance and the blue quantum dot color resistance to separate the red quantum dot color resistance, the green light quantum dot color resistance and the blue quantum dot color resistance.

In one embodiment of the disclosure, the quantum dot liquid crystal panel further comprises a plurality of pillars disposed between the array substrate and the color film substrate. The plurality of pillars are disposed corresponding to the plurality of reflecting layers.

In comparison with the prior art, the quantum dot liquid crystal panel, and the method manufacturing the same of the embodiments of the disclosure ensure that the QDs performance is not destroyed by adopting a self-aligning liquid crystal material, and reducing one PI process. The self-aligned liquid crystal material can realize liquid crystal alignment under low temperature conditions because the alignment temperature of the self-aligned liquid crystal material only needs to be higher than the clearing point of the liquid crystal. At the same time, if PIs are used, PIs need to be coated on the nanoimprinted polarizer. But the combination of organic and inorganic materials has problem that the PI liquid cannot be adsorbed on the polarizer. There is a risk of poor alignment. However, the application of the self-aligning liquid crystal material of the disclosure can solve the problem that PIs do not adsorbed on the polarizer.

### BRIEF DESCRIPTION OF DRAWINGS

FIG. 1 is a schematic flowchart of a method manufacturing a quantum dot liquid crystal panel according to an embodiment of the disclosure.

FIG. 2 a schematic structural view of a quantum dot liquid crystal panel according to an embodiment of the disclosure.

### DETAILED DESCRIPTION OF PREFERRED EMBODIMENTS

The following description of the embodiments is provided by reference to the following drawings and illustrates the specific embodiments of the present disclosure. Directional terms mentioned in the present disclosure, such as “up,” “down,” “top,” “bottom,” “forward,” “backward,” “left,” “right,” “inside,” “outside,” “side,” “peripheral,” “central,” “horizontal,” “peripheral,” “vertical,” “longitudinal,” “axial,” “radial,” “uppermost” or “lowermost,” etc., are merely indicated the direction of the drawings. Therefore, the directional terms are used for illustrating and understanding of the application rather than limiting thereof.

The disclosure is directed to the current state of liquid crystal panels of prior art that they cannot achieve low temperature alignment when using an alignment liquid for alignment. High temperature will destroy the performance of QDs. At the same time, there is a technical problem that the alignment liquid cannot be adsorbed on a nanoimprinted polarizer surface. The embodiment of the disclosure can solve this defect.

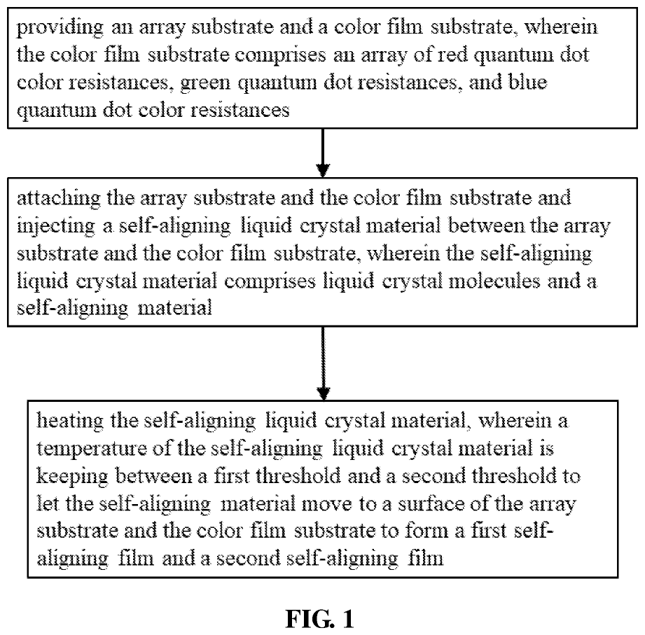

FIG. 1 is a schematic flowchart of a method manufacturing a quantum dot liquid crystal panel according to an embodiment of the disclosure.

One embodiment of the disclosure provides a method of manufacturing a quantum dot liquid crystal panel comprising steps of the following:

At step S10, providing an array substrate and a color film substrate, wherein the color film substrate comprises an array of red quantum dot color resistances, green quantum dot resistances, and blue quantum dot color resistances.

In detail, the array substrate comprises common layers, such as a thin film transistor layer, a common electrode layer, etc. The color film substrate further comprises a black array disposed between the red quantum dot color resistances, the green quantum dot resistances, and the blue quantum dot color resistances. Material of the red quantum dot color resistances, the green quantum dot resistances, and the blue quantum dot color resistances are quantum dot materials and emit red light, green light, and blue light, respectively, after excitation by a blue backlight source.

At step S20, attaching the array substrate and the color film substrate and injecting a self-aligning liquid crystal material between the array substrate and the color film substrate, wherein the self-aligning liquid crystal material comprises liquid crystal molecules and self-aligning material.

In detail, the self-aligning liquid crystal material comprises liquid crystal molecules and a self-aligning material in a certain formula. One may apply the self-aligning liquid crystal material on the array substrate by one drop filling (ODF) or inkjet, cover the array substrate by the color film substrate, seal the outer rim between the array substrate and the color film substrate by a sealant, and cure the sealant to obtain a liquid crystal case.

In one embodiment of the disclosure, one may align and attach the array substrate with the color film substrate by a vacuum aligner system (VAS).

At step S30, heating the self-aligning liquid crystal material, wherein a temperature of the self-aligning liquid crystal material is keeping between a first threshold and a second threshold to let the self-aligning material move to a surface of the array substrate and the color film substrate to form a first self-aligning film and a second self-aligning film.

In detail, heating the self-aligning liquid crystal material, wherein the temperature of the self-aligning liquid crystal material is keeping between the first threshold and the second threshold. Because performance of luminous efficiency of the quantum dot materials will be destroyed when the quantum dot materials are under a high temperature condition, for example, exceed 150 □. Therefore, the heating temperature in the disclosure needs to be controlled within a certain range. A preferred first threshold is a temperature corresponding to liquid crystal molecules reaching its clearing point, and a preferred second threshold is 150 □.

After the self-aligning liquid crystal material is heated, the self-aligning material moves to a surface of the array substrate and a surface of the color film substrate to form a first self-aligning film on the surface of the array substrate and a second self-aligning film on the surface of the color film substrate, respectively. And simultaneously forming a liquid crystal layer between the first self-aligning film and the second self-aligning film.

In detail, the materials of the first self-aligning film and the second self-aligning film are the self-aligning materials in the self-aligning liquid crystal material, and the material of the liquid crystal layer is the liquid crystal molecules of the self-aligning liquid crystal material.

Because the heating temperature is between the first threshold and the second threshold, the self-aligning liquid crystal material may be reacted to form the liquid crystal layer, the first self-aligning film, and the second self-aligning film. At the same time, it is guaranteed that the performance of the quantum dot material will not be destroyed.

At step S40, aligning liquid crystal molecules by exposing to ultraviolet (UV) light.

The array substrate is provided with a first electrode, and the color film substrate is provided with a second electrode. The first electrode is a common electrode and the second electrode is a pixel electrode, respectively. The liquid crystal case is irradiated with ultraviolet rays while applying a voltage to both sides of the liquid crystal case. In detail, a voltage is applied across the liquid crystal case by applied a voltage between the first electrode and the second electrode.

In detail, because the liquid crystal molecules and the self-aligning material in the self-aligning liquid crystal material are uniformly mixed, the thickness of the first self-aligning film and the second self-aligning film formed by the self-aligning material is relatively uniform.

When removing the voltage on both sides of the liquid crystal case, the liquid crystal molecules in the liquid crystal layer generate a pretilt angle under the action of the first self-aligning film and the second self-aligning film.

In addition, the method for manufacturing the quantum dot liquid crystal panel further includes the steps of: applying a sealant and curing the sealant. The step of applying the sealant is before the step that the array substrate and the color film substrate are aligned and attached. The step of applying the sealant includes applying the sealant on the periphery of the self-aligning liquid crystal material on the color film substrate or the array substrate. The step of curing the sealant is before the step of applying voltage on both sides of the liquid crystal case. The step of curing the sealant includes at least one method of UV curing and heat curing.

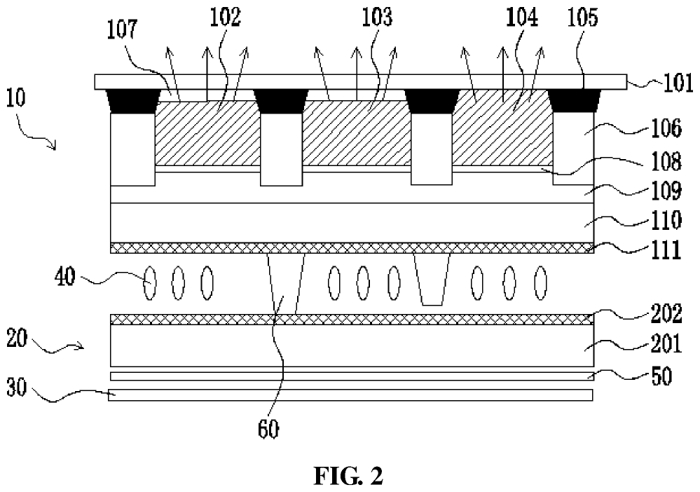

Referring to FIG. 2, another embodiment of the disclosure provides a quantum dot liquid crystal panel comprising a color film substrate 10, an array substrate 20, and a blue backlight source 30 disposed at one side of the array substrate 20. A liquid crystal layer 40 is disposed between the color film substrate 10 and the array substrate 20. A polarizer 50 is disposed between the array substrate 20 and the blue backlight source 30.

The color film substrate 10 comprises a base substrate 101, a red quantum dot color resistance 102, a green light quantum dot color resistance 103, and a blue quantum dot color resistance 104 repeatedly disposed on the base substrate 101 in intervals. A black shading layer 105 is further provided on the base substrate 101. The black shading layer 105 is disposed in intervals between the red quantum dot color resistance 102, the green light quantum dot color resistance 103, and the blue quantum dot color resistance 104. A plurality of reflecting layers 106 corresponding to the position of the black shading layer 105 are disposed between the red quantum dot color resistance 102, the green light quantum dot color resistance 103, and the blue quantum dot color resistance 104 to separate the red quantum dot color resistance 102, the green light quantum dot color resistance 103, and the blue quantum dot color resistance 104. The A water oxygen barrier layer 108 is disposed on a side of the red quantum dot color resistance 102, the green light quantum dot color resistance 103, and the blue quantum dot color resistance 104 opposite to another side of the red quantum dot color resistance 102, the green light quantum dot color resistance 103, and the blue quantum dot color resistance 104 facing the base substrate 101. The water oxygen barrier layer 108 is a light transmissive material that blocks water and oxygen permeation. An optical clear (OC) photoresist layer 109 is disposed on the water oxygen barrier layer 108, and a second electrode layer 110 is disposed on the OC photoresist layer 109.

The array substrate 20 and the color film substrate 10 are disposed opposite to each other. The array substrate 20 includes a thin film transistor 201, a first electrode layer (not shown), and etc.

The liquid crystal layer 40 is disposed between the color film substrate 10 and the array substrate 20. The first self-aligning film 202 is formed on a surface of the array substrate 20 facing the color film substrate 10. The second self-aligning film 111 is formed on a surface of the color film substrate 10 facing the array substrate 20. The liquid crystal layer 40, the first self-aligning film 202, and the second self-aligning film 111 are formed by the self-aligning liquid crystal material. The self-aligning liquid crystal material comprises liquid crystal molecules and the self-aligning material.

The quantum dot liquid crystal panel further comprises a plurality of pillars 60 disposed between the array substrate 20 and the color film substrate 10. The plurality of pillars 60 are disposed corresponding to the plurality of reflecting layers 106. Heights of the plurality of pillars 60 are different for the self-aligning material uniformly attached the array substrate 20 and color film substrate 10.

The blue backlight source 30 is disposed on one side of the array substrate 20 opposite to another side of the array substrate 20 facing the color film substrate 10. The blue backlight source 30 is configured to provide blue light. The quantum dot liquid crystal panel further comprises a blue light absorption layer 107 between the red quantum dot color resistance 102 and the base substrate 101, and between the green light quantum dot color resistance 103 and the base substrate 101. The red quantum dot color resistance 102 and the green light quantum dot color resistance 103 are disposed between the blue light absorption layer 107 and the blue backlight source 30 for absorbing the blue light penetrating the red quantum dot color resistance 102 and the green light quantum dot color resistance 103 by the blue light absorption layer 107 to enhance the color gamut.

In comparison with prior art, the quantum dot liquid crystal panel and the method manufacturing the same of the embodiments of the disclosure ensure that the performance of QDs is not destroyed by adopting a self-aligning liquid crystal material, and reducing one PI process. The self-aligned liquid crystal material can realize liquid crystal alignment under low temperature conditions because the alignment temperature of the self-aligned liquid crystal material only needs to be higher than the clearing point of the liquid crystal. At the same time, if PIs are used, PIs need to be coated on the nanoimprinted polarizer. But the combination of organic and inorganic materials has a problem that the PI liquid cannot be adsorbed on the polarizer. There is a risk of poor alignment. However, the application of the self-aligning liquid crystal material of the disclosure can solve the problem that PIs do not adsorbed on the polarizer.

The present disclosure has been described by the above embodiments, but the embodiments are merely examples for implementing the present disclosure. It must be noted that the embodiments do not limit the scope of the invention. In contrast, modifications and equivalent arrangements are intended to be included within the scope of the invention.

What is claimed is:

1. A method of manufacturing a quantum dot liquid crystal panel, comprising steps of:
step S10: providing an array substrate and a color film substrate, wherein the color film substrate comprises an array of red quantum dot color resistances, green quantum dot resistances, and blue quantum dot color resistances;
step S20: attaching the array substrate and the color film substrate and injecting a self-aligning liquid crystal material between the array substrate and the color film substrate, wherein the self-aligning liquid crystal material comprises liquid crystal molecules and a self-aligning material; and
step S30: heating the self-aligning liquid crystal material, wherein a temperature of the self-aligning liquid crystal material is keeping between a first threshold and a second threshold to let the self-aligning material move to a surface of the array substrate and the color film substrate to form a first self-aligning film and a second self-aligning film.

2. The method according to claim 1, wherein the first threshold is a temperature corresponding to the liquid crystal molecules reaching its clearing point, and the second threshold is 150° C.

3. The method according to claim 1, further comprising steps of:
step S40: aligning the liquid crystal molecules by exposing to ultraviolet light.

4. A quantum dot liquid crystal panel, comprising:
a color film substrate, wherein the color film substrate comprises a base substrate and a red quantum dot color resistance, a green light quantum dot color resistance, and a blue quantum dot color resistance repeatedly disposed on the base substrate in intervals;
an array substrate, wherein the array substrate and the color film substrate are disposed opposite to each other;
a blue backlight source, wherein the blue backlight source is disposed on one side of the array substrate opposite to another side of the array substrate facing the color film substrate;
a liquid crystal layer disposed between the color film substrate and the array substrate;
a first self-aligning film formed on a surface of the array substrate facing the color film substrate; and
a second self-aligning film formed on a surface of the color film substrate facing the array substrate, wherein the liquid crystal layer, the first self-aligning film, and the second self-aligning film are formed by a self-aligning liquid crystal material at a temperature between a first threshold and a second threshold.

5. The quantum dot liquid crystal panel according to claim 4, wherein the self-aligning liquid crystal material comprises liquid crystal molecules and a self-aligning material.

6. The quantum dot liquid crystal panel according to claim 5, wherein the first threshold is a temperature corresponding to liquid crystal molecules reaching its clearing point, and the second threshold is 150° C.

7. The quantum dot liquid crystal panel according to claim 4 further comprising a blue light absorption layer between the red quantum dot color resistance and the base substrate, and between the green light quantum dot color resistance and the base substrate.

8. The quantum dot liquid crystal panel according to claim 4 further comprising a water oxygen barrier layer disposed on the red quantum dot color resistance, the green light quantum dot color resistance, and the blue quantum dot color resistance wherein the water oxygen barrier layer is a light transmissive material.

9. The quantum dot liquid crystal panel according to claim 4 further comprising a black shading layer disposed in intervals between the red quantum dot color resistance, the green light quantum dot color resistance, and the blue quantum dot color resistance to separate the red quantum dot color resistance, the green light quantum dot color resistance, and the blue quantum dot color resistance.

10. The quantum dot liquid crystal panel according to claim 4 further comprising a plurality of reflecting layers disposed between the red quantum dot color resistance, the green light quantum dot color resistance, and the blue quantum dot color resistance to separate the red quantum dot color resistance, the green light quantum dot color resistance, and the blue quantum dot color resistance.

11. The quantum dot liquid crystal panel according to claim 10 further comprising a plurality of pillars disposed between the array substrate and the color film substrate, wherein the plurality of pillars are disposed corresponding to the plurality of reflecting layers.

12. A quantum dot liquid crystal panel, comprising:
a color film substrate, wherein the color film substrate comprises a base substrate and a red quantum dot color resistance, a green light quantum dot color resistance, and a blue quantum dot color resistance repeatedly disposed on the base substrate in intervals;
an array substrate, wherein the array substrate and the color film substrate are disposed opposite to each other;
a blue backlight source, wherein the blue backlight source is disposed on one side of the array substrate opposite to another side of the array substrate facing the color film substrate;
a liquid crystal layer disposed between the color film substrate and the array substrate;
a first self-aligning film formed on a surface of the array substrate facing the color film substrate; and
a second self-aligning film formed on a surface of the color film substrate facing the array substrate, wherein the liquid crystal layer, the first self-aligning film, and the second self-aligning film are formed by a self-aligning liquid crystal material.

13. The quantum dot liquid crystal panel according to claim 12, wherein the self-aligning liquid crystal material comprises liquid crystal molecules and a self-aligning material.

14. The quantum dot liquid crystal panel according to claim 12 further comprising a blue light absorption layer between the red quantum dot color resistance and the base substrate, and between the green light quantum dot color resistance and the base substrate.

15. The quantum dot liquid crystal panel according to claim 12 further comprising a water oxygen barrier layer disposed on the red quantum dot color resistance, the green light quantum dot color resistance, and the blue quantum dot color resistance wherein the water oxygen barrier layer is a light transmissive material.

16. The quantum dot liquid crystal panel according to claim 12 further comprising a black shading layer disposed in intervals between the red quantum dot color resistance, the green light quantum dot color resistance, and the blue quantum dot color resistance to separate the red quantum dot color resistance, the green light quantum dot color resistance, and the blue quantum dot color resistance.

17. The quantum dot liquid crystal panel according to claim 12 further comprising a plurality of reflecting layers disposed between the red quantum dot color resistance, the green light quantum dot color resistance, and the blue quantum dot color resistance to separate the red quantum dot color resistance, the green light quantum dot color resistance, and the blue quantum dot color resistance.

18. The quantum dot liquid crystal panel according to claim 17 further comprising a plurality of pillars disposed between the array substrate and the color film substrate, wherein the plurality of pillars are disposed corresponding to the plurality of reflecting layers.
